(19) United States
(12) Patent Application Publication
(10) Pub. No.: US 2005/0116535 A1
(43) Pub. Date: Jun. 2, 2005

(54) Fluid accumulator and brake bias system incorporating fluid accumulator

(76) Inventors: Craig A. Paulsen, Reno, NV (US); Phil L. Perry, Lincoln, CA (US)

Correspondence Address: WEIDE & MILLER, LTD., 7251 W. LAKE MEAD BLVD., SUITE 530, LAS VEGAS, NV, 89128, US

(21) Appl. No.: 10/982,989

(22) Filed: Nov. 5, 2004

Related U.S. Application Data
(60) Provisional application No. 60/526,167, filed on Dec. 1, 2003.

(51) Int. Cl. B60T 17/04

(52) U.S. Cl. 303/87

(57) ABSTRACT

A fluid accumulator for a brake system includes a housing. A piston is movably mounted in the housing, the piston and housing defining a fluid chamber. A port leads through the housing to the chamber. A spring or other biasing element forces the piston towards one end of the housing. In one embodiment, one end of the spring is mounted to a rod which extends from the housing. The position of the rod maybe changed to change the spring biasing force on the piston. A brake system includes a balance bar actuating two master cylinders, each providing fluid to a fluid line leading to one or more braking mechanisms. An accumulator is located along one of the lines for accumulating fluid and preventing brake lock.

### RELATED INVENTION

The present invention claims priority to U.S. Provisional Patent Application Ser. No. 60/526,167 filed Dec. 1, 2003.

### FIELD OF THE INVENTION

The present invention relates to brake systems. More particularly, the invention relates to a brake system including a fluid accumulator and fluid accumulators for brake systems.

### BACKGROUND OF THE INVENTION

Hydraulic brake systems in high performance or race vehicles often utilize dual master cylinders or a production-style tandem master cylinder. Tandem master cylinders use one cylinder bore with two pressure ports and pistons. They are designed so that if pressure is lost in either port, the other port maintains its pressure. Dual master cylinder set-ups completely isolate the two hydraulic systems. One system connects to the front wheels, while the other connects to the rear wheels.

Dual master cylinder systems allow braking force to be varied between the front and rear wheels. Selection of the applied braking force in such systems, including the braking force applied by the front as compared to the rear wheels (which may be referred to as “brake bias”), can be very important. In a racing environment, it is particularly important to control braking to maximize braking effect, but prevent wheel lock-up.

Among other things, as a car decelerates or enters a corner, weight is transferred from the rear to the front tires. The exact amount of weight shift depends on the speed of the car, track, corner, and how much brake is applied upon entry. This weight transfer reduces the amount of braking force the rear tires can produce.

The driver maybe permitted to adjust the brake system before, after or during a race, or practice sessions, to change the precise adjustment of the front to rear bias setting, allowing for changing track conditions or to optimize brake performance. The correct front brake bias setting depends on the driver's driving style and how hard or how much the brakes are used when entering a corner. Since this will vary with each corner at each track, it is important to find the right balance as not to upset the chassis when the brakes are applied while cornering.

Unfortunately, adjustments in the brake bias may actually contribute to brake lock. For example, in order to counter the loss in braking force at the rear wheels associated with weight shift, the applied braking force to the rear wheels is generally increased. When the brakes are applied suddenly, however, the rear brake bias often results in excessive braking force, causing rear wheel lock-up and associated loss of traction and control.

Some attempts have been made to address this lock-up issue, but these attempts have been unsuccessful in resolving the problem. Commonly, proportioning valves are utilized in these types of brake systems. These proportioning valves serve to reduce line pressure downstream of the valve relative to the pressure upstream of the valve, generally in the form of a percentage pressure reduction. While these valves can be relatively effective in preventing brake lock when brakes are applied slowly, they are not effective in preventing brake lock when brakes are applied quickly with high force. In those situations, a very high line pressure is generated by the quick, hard application of the brakes. The proportioning valve reduces the downstream line pressure, but that reduction, being only a percentage reduction, is relatively small compared to the total line pressure, such that the downstream pressure is still very high, causing the brakes to lock.

An improved braking system which overcomes these disadvantages is desired.

### SUMMARY OF THE INVENTION

The present invention is a fluid accumulator for a brake system and a brake system including at least one fluid accumulator.

A vehicle braking system comprises a first master cylinder and at least one first fluid line leading from that first master cylinder to at least one first fluid-actuated braking mechanism. The braking system includes a second master cylinder and at least one second fluid line leading from that second master cylinder to at least one second fluid-actuated braking mechanism.

In one embodiment, the first master cylinder provides fluid to braking mechanisms associated with the front wheels of a vehicle. The second master cylinder provides fluid to braking mechanisms associated with the rear wheels of the vehicle.

The braking system includes an actuating member for actuating the first and second master cylinders to cause the first and second master cylinders to dispense fluid into the at least one first and at least one second fluid lines, respectively. Preferably, the position of the actuating member is adjustable so that the amount of fluid dispensed by the first and second master cylinders relative to one another may be adjusted.

In one embodiment, the actuating member includes a brake pedal linked to a balance bar, the balance bar configured to activate the first and second master cylinders via a pair of links or arms. The position of the balance bar may be changed so that the force applied to each link via the brake pedal, and thus the master cylinders, varies.

The brake system further includes at least one fluid accumulator associated with the at least one second fluid line, the accumulator configured to selectively accumulate fluid which is dispensed into the at least one second fluid line by the second master cylinder.

In one embodiment, the brake system is associated with a race car. The balance bar is utilized to bias the braking force to the rear wheels. The accumulator is associated with the fluid line leading to the rear wheel braking mechanisms for accumulating brake fluid to prevent rear wheel lock-up.

Various embodiments of the invention comprise a fluid accumulator, such as for use with the brake system of the invention.

In one embodiment, the fluid accumulator includes a housing defining an interior space. A body, preferably in the form of a piston, is movably mounted in the interior space and cooperates with the housing to define a fluid chamber. The accumulator includes at least one port through the housing leading to the fluid chamber through which fluid may pass to and from a fluid line or other fluid source.

At least one member generates a biasing force which is applied to the body, causing the body to move to a position wherein the size of said fluid chamber is reduced. In one embodiment, this member comprises a spring mounted in the housing which engages the piston.

Preferably, the accumulator includes a means for adjusting the biasing force generated by the bias generating member. In one embodiment, one end of the spring is mounted to a spring mount. The spring mount is movable with a rod which is connected to the housing. Movement of the rod changes the position of the spring mount, and thus the position of one end of the spring relative to the other end of the spring which engages the piston, thus changing the bias force.

Various objects, features, and advantages of the present invention over the prior art will become apparent from the detailed description of the drawings which follows, when considered with the attached figures.

### BRIEF DESCRIPTION OF THE DRAWINGS

FIG. 1 is a cross-sectional view of a fluid accumulator for a brake system in accordance with one embodiment of the invention;

FIG. 2 is a cross-sectional view of a fluid accumulator for a brake system in accordance with another embodiment of the invention; and

FIG. 3 schematically illustrates a balance bar brake bias system having a fluid accumulator in accordance with an embodiment of the invention.

### DETAILED DESCRIPTION OF THE INVENTION

The invention comprises a fluid accumulator for a hydraulic braking system and a brake system including an accumulator. In the following description, numerous specific details are set forth in order to provide a more thorough description of the present invention. It will be apparent, however, to one skilled in the art, that the present invention maybe practiced without these specific details. In other instances, well-known features have not been described in detail so as not to obscure the invention.

In general, the invention comprises a fluid accumulator for a hydraulic brake system. Another embodiment of the invention comprises an adjustable hydraulic brake system including a fluid accumulator.

The fluid accumulator of the invention has particular applicability to brake systems utilized on vehicles, and most preferably, vehicles having both at least one front and rear wheel. Such vehicles include cars and trucks, including passenger and racing vehicles, as well as karts/go-karts, motorcycles, airplanes, trains and other moving bodies.

The accumulator of the invention is useful with brake systems in which braking force is generated by moving two bodies into contact with one another. In one embodiment, movement is effectuated with a hydraulic force, such as applied fluid.

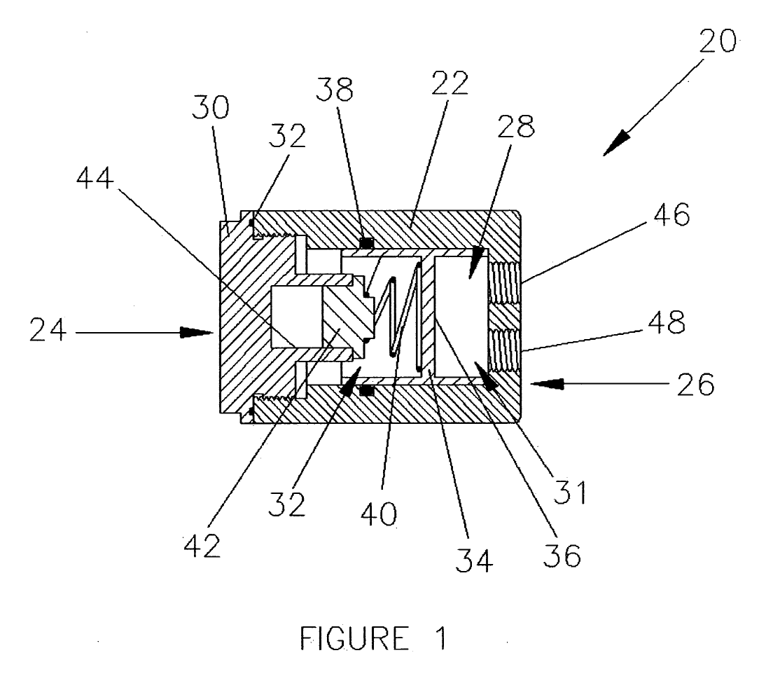

FIG. 1 illustrates one embodiment of a fluid accumulator 20 in accordance with the present invention. The accumulator 20 includes a housing 22 or body. In one embodiment, the housing 22 is generally cylindrical in shape and has a first end 24 and a second end 26. The first end 24 is generally open and leads to an interior space 28 defined by the housing 22. As illustrated, the interior space 28 is also generally cylindrical in shape, thus having a circular cross-sectional shape.

Preferably, an end cap 30 selectively closes the first end 24 of the housing 22. In one embodiment, the end cap 30 has threads on at least a portion of the exterior thereof for engaging mating threads provided on the housing 22. In this manner, the end cap 30 maybe connected and disconnected from the housing 22, thus providing access to the interior 28 of the housing 22, such as during assembly.

In one embodiment, at least one seal 32 is provided between the end cap 30 and the housing 22 to provide a fluid seal. When the housing 22 is cylindrical in shape, the seal 32 maybe circular in shape. The seal 32 may be, for example, an “O”-ring or the like.

A body is movably mounted in the housing 22. In a preferred embodiment, the body is a piston 34 mounted in the interior 28 of the housing 22. As illustrated, the piston 34 comprises a generally open cylindrical member having an internal dividing wall or member 36. Preferably, the piston 34 is sized so that its outer surface is closely spaced to the inside of the housing 22, but yet still permits the piston 34 to move inside of the housing 22 relative to the housing 22.

As illustrated, the dividing wall 36 of the piston 34 effectively divides the interior 28 of the housing 22 into a first chamber 31 and a second chamber 32. The first chamber 31 is located between the dividing wall 36 of the piston 34 and the second end 26 of the housing 22. The second chamber 32 is located between the dividing wall 36 of the piston 34 and the end cap 30.

In a preferred embodiment, these two chambers 31,32 are in fluid isolation. At least one seal 38 maybe provided between the housing 22 and the piston 34 for this purpose. As illustrated, the seal 38 is an O-ring which is mounted to the housing 22, such as in a channel formed in the housing. Again, when the housing 22 is cylindrical in shape, the seal 38 may be circular in shape.

Means are preferably provided for biasing the piston 34 in the direction of the second end 26 of the housing 22. In one embodiment, as illustrated, this means comprises a spring 40. In a preferred embodiment, the spring 40 is a conical coil spring.

In one embodiment, a spring mount 42 is connected to the end cap 30. In particular, as illustrated, the end cap 30 has a first end which is located inside of the housing 22 when it is connected to the housing 22. That end includes a mount 44 comprising a generally cylindrical open wall. The spring mount 42 comprises a generally cylindrical body having a first end which engages the mount 44. Of course, the mount 42 might also be integrally formed with the cap 30.

As illustrated, a second end of the mount 44 is configured to accept one end of the spring 40. As illustrated, a first end of the spring 40 may seat on a cylindrical extension of the mount 44. The second end of the spring 40 preferably engages the piston 34. As illustrated, the second end of the spring 40 engages the dividing wall 36 of the piston. In this configuration, the spring 40 biases or presses the piston 34 towards the second end 26 of the housing 22.

The housing 22 includes a port or passage 46 leading to the first chamber 31. In one embodiment, the passage 46 is defined through the second end 26 of the housing 22. As illustrated, an interior of the passage 46 maybe threaded for accepting a fitting. Preferably, the fitting is configured to connected to a fluid line of a hydraulic brake system.

In one embodiment, the housing 22 also includes a bleed port or passage 48. Preferably, the bleed passage 48 also leads to the first chamber 31. As illustrated, the bleed passage 48 is defined through the second end 26 of the housing 22. The bleed passage 48 maybe similarly threaded to engage a bleed fitting.

Operation of this embodiment accumulator 20 is as follows. The accumulator 20 is located along a fluid path so that fluid may flow into and out of the first chamber 31 through the fluid port 46. In one embodiment, a “T” fitting maybe located along a fluid line, with one end of the “T” connected to the fluid port 46.

Once connected, the first chamber 31 is preferably filled with fluid. Air within the chamber 31 is preferably bled out of the chamber via the bleed port 48, such as by opening a bleed fitting connected thereto.

Under normal operating pressures, the piston 34 is biased towards the second end 26 of the housing 20, reducing the size of the first chamber 31. In response to the introduction of additional fluid into the brake system, such as via a master cylinder, and the associated high fluid pressure resulting therefrom, fluid flows into the first chamber 31. In particular, the pressure of the fluid causes the piston 34 to move against the spring 40 towards the first end 24 of the housing 22. As this occurs, the size of the first chamber 31 increases, allowing fluid to accumulate in the first chamber 31. When the fluid pressure in the line decreases, the piston 34 forces fluid back out of the first chamber 31 as the size of the chamber is reduced when the piston 34 is biased back towards the second end 26 of the housing 22. Movement of the piston 34 towards the second end 26 of the housing 22 is limited by contact of the piston 34 with the housing 22. Movement of the piston 34 towards the first end 24 of the housing 22 maybe limited in high pressure situations by contact with the spring mount 42, which also serves as a piston stop.

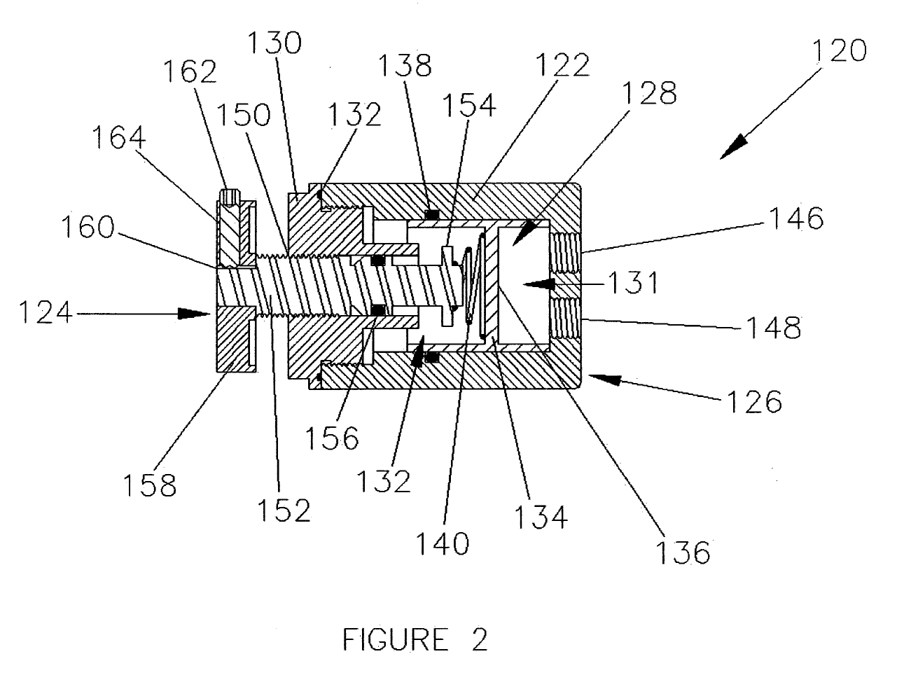

FIG. 2 illustrates another embodiment of a fluid accumulator 120 in accordance with the invention. Once again, the accumulator 120 includes a housing 122 having a first end 124, second end 126 and interior 128. An end cap 130 is located at the first end 124 of the housing 122, the end cap 130 sealed to the housing 122 with one or more seals 132.

A piston 134 or other body is again movably located in the housing 122. The piston 134 again includes a divider portion 136. One or more seals 138 preferably seal the piston 134 and the housing 122, thus dividing the interior of the housing into a first chamber 131 and a second chamber 132. First and second ports 146,148 or passages are again provided through the housing 122 to the second chamber 132. These ports 146,148 have the same purpose as the ports 46,48 described above.

Once again, means are preferably provided for biasing the piston 134 towards the second end 126 of the housing 122. In one embodiment, this means again comprises a spring 140.

Preferably, in this embodiment, means are provided for selecting or adjusting the biasing force which is applied to the piston 134. In the embodiment illustrated, this means comprises a means for changing the position of a spring mount.

As illustrated, the end cap 130 defines a passage 150 there through. A rod 152 extends through the passage 150. In a preferred embodiment, at least a portion of the passage 150 is threaded for engagement with threads on the exterior of the rod 152. In this manner, the relative position of the rod 152 to the end cap 130 maybe adjusted. In one embodiment, to maintain a fluid seal, at least one seal 156 may be located between the rod 152 and end cap 130.

As illustrated, the rod 152 has a generally circular cross-sectional shape, as does the passage 150. The passage 150 and rod 152 preferably extend along a centerline of the housing 122 extending through the first and second ends 124,126 of the housing 122.

The rod 152 has a first end and a second end. In one embodiment, the first end of the rod 152 defines a spring mount 154. A head or knob 158 is preferably located at the second end of the rod 152. In one embodiment, the knob 158 maybe detached from the rod 152. As illustrated, the knob 158 defines a passage 160 for accepting the second end of the rod 152. A set screw 162 preferably extends through a counter-passage 164 in the knob 158 into selective engagement with the rod 152. When tightened, the set screw 152 secures the knob 158 to the rod 152.

The knob 158 maybe knurled on its exterior surface for gripping by a user. The set screw 162 maybe configured to extend from the knob 158 to provide a visual indicator of the relative rotational position of the rod 152 to the housing 122. Other such indicators might be provided, however, such as surface etchings or markings provided on the knob 158 and/or housing 122.

Operation of this embodiment accumulator 120 is similar to that illustrated in FIG. 1 and described above. In this embodiment, however, the force applied by the spring 140 to the piston 134 may be varied. In particular, by moving the rod 152 outwardly of the end cap 130 (such as by rotating it in a counter-clockwise direction), the spring mount 154 is moved towards the first end 124 of the housing 122. In this position, the distance between the mount 154 and the piston 134 is maximized, and the spring 140 is relatively uncompressed, lessening the force it applies to the piston 134.

On the other hand, by moving the rod 152 inwardly relative to the end cap 130, the spring mount 154 moves and compresses the spring 140. This causes the spring 140 to generate a higher biasing force as applied to the piston 134.

By changing the bias force which is generated by the spring 134, the fluid pressure which is necessary to move the piston 134 and thus cause fluid accumulation, is changed. As described below, this has numerous advantages.

The components of the accumulators of the invention maybe constructed of a wide variety of materials. In one embodiment, the housing, end cap, piston and knob maybe constructed of aluminum, while the set screw, rod and spring maybe constructed of steel. Seals maybe constructed of a variety of materials, including Buna N elastomer material.

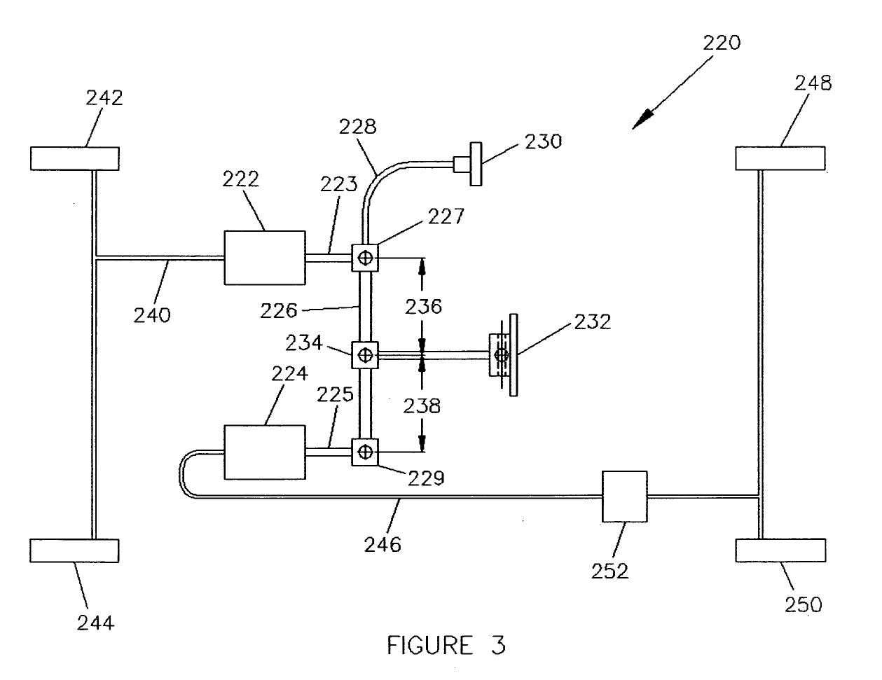

One embodiment of the invention is a brake or braking system including a fluid accumulator. Referring to FIG. 3, in a preferred embodiment, the brake system 220 includes a first brake master cylinder 222 and a second brake master cylinder 224. In one embodiment, the first master cylinder 222 provides fluid to one or more front wheel brake mechanisms of a vehicle, and the second master cylinder 224 provides fluid to one or more rear wheel brake mechanisms.

The system 220 includes means for controlling or adjusting the actuation of the first and second master cylinders 222,224 relative to one another. In one embodiment, this means includes a threaded adjustable brake bias rod or bar 226. As illustrated, the brake bias rod 226 actuates the first or front and second or rear brake master cylinders 222,224.

In a preferred embodiment, the brake system 220 includes a brake pedal 232. The brake pedal 232 actuates the brake bias rod 226 via a connecting arm or lever. In turn, the brake bias rod 226 acts upon the front and rear brake master cylinders 222,224 via first and second rods, levers, arms or other connections 223,225 at first and second connections 227,229.

A point of activation 234 of the brake bias rod 226 by the brake pedal 232 is preferably adjustable. In particular, the location of the point of activation 234 can be changed via rotation of the brake bias rod with a cable 228, as actuated by a knob 230. Preferably, the knob 230 is located inside a driver compartment of the vehicle, and thus is accessible to the driver. Other means to change the location of the point of activation 234 may also be utilized.

When the knob 230 is turned by the driver, the driver changes the brake bias between the front and rear brakes of the race car. In particular, as the knob 230 is turned, the bias rod 226 rotates, changing its position. As the position of the brake bias rod 226 changes, so does the point of activation 234. As the point of activation 234 changes, so does the length of the brake bias bar 226 on each side of the point of activation. In particular, as illustrated, the brake bias bar 226 has a first portion 236 located between the point of activation 234 and the front brake master cylinder 222, and a second portion 238 which is located between the point of activation 234 and the rear brake master cylinder 224.

It will be appreciated that if the length of both portions 236,238 of the brake bias rod 226 is the same, then the amount of force which is applied to the front and rear brake master cylinders 222,224 via the brake pedal 232, is equal. If the length of the first portion 236 is greater than the length of the second portion 238, then there is a decreased mechanical advantage and a lesser force applied to the front brake master cylinder 222 than the rear brake master cylinder 224. In this arrangement, the hydraulic pressure used to actuate the front brakes is less than that used to actuate the rear brakes. Alternatively, if the length of the second portion 238 is greater than the length of the first portion 236, then there is a decreased mechanical advantage and a lesser force applied to the rear brake master cylinder 224. In this arrangement, the hydraulic pressure used to actuate the rear brakes is less than that used to actuate the front brakes.

The front brake master cylinder 222 is connected by at least one fluid line 240 to a right front brake caliper 242 and a left front brake caliper 244. These calipers 242,244 are preferably associated with braking mechanisms for the right and left front wheels of the vehicle.

Similarly, the rear brake master cylinder 224 is connected by at least one fluid line 246 to a right rear brake caliper 248 and a left rear brake caliper 250. These calipers 248,250 are preferably associated with braking mechanisms for the right and left rear wheels of the vehicle.

As indicated, a wheel braking mechanism is preferably associated with one or more of the wheels of the vehicle. When the braking mechanism is activated, such as via hydraulic pressure transitted by fluid through the brake lines, the braking mechanism is configured to impede the rotation of the wheel. In one embodiment, each wheel braking mechanism is a disc-type braking system which includes a caliper, a rotor and at least one pad. The pad is mounted to the caliper. The pad is mounted for movement towards and away from the rotor in response to hydraulic pressure. When the pad moves towards the rotor under applied hydraulic pressure, the pad presses upon the rotor. The rotor is preferably mounted to the wheel or a support for the wheel, such that braking of the rotor results in braking of the wheel.

It will be appreciated that other means or configurations may be provided for selectively controlling the actuation of the first and second master cylinders relative to one another. For example, in a “drive by wire” configuration, two solenoids might move master cylinder actuating levers in response to the actuation of the brake pedal. The amount of actuation of the solenoids might be controlled differently, so that the amount of braking force generated at the front and rear portions of the braking system varies.

The brake system 220 includes a fluid accumulator 252. Preferably, the fluid accumulator 252 comprises accumulator 20 illustrated in FIG. 1 or accumulator 120 illustrated in FIG. 2, both described above. The accumulator may be of other types, however.

In a preferred embodiment, the accumulator 252 is associated with the rear wheel braking system(s). As illustrated, the accumulator 252 is located between the rear wheel master cylinder 224 and the rear wheel braking mechanisms 248,250. Preferably, the accumulator 252 is located along the fluid line 246 or path through which fluid is provided from the rear wheel master cylinder 224 and the rear wheel braking mechanisms.

As indicated above, in one embodiment, a “T” fitting maybe provided along that line. One port of the “T” fitting maybe connected to the fluid port of the fluid accumulator 252, permitting fluid to flow into and out of the accumulator.

As described, the front and rear wheel braking mechanism may include calipers. These calipers maybe configured to move brake pads into and out of engagement with a rotor or “disc” located at each wheel. The brake system, however, may include “drum” type braking mechanisms, rather than “disc”0 type braking mechanisms.

During normal operation of the brake system 220, fluid pressure within the system, including fluid line 246, is relatively low. When the brakes are applied very quickly, as when a driver applies the brakes when entering a turn of a race-course, fluid pressure in the system increases via actuation of the front and rear master cylinders 222,224. The fluid pressure increases due to the front and rear master cylinders 222,224 pushing fluid into the fluid lines 240,246. Because the volume of fluid is increased within the otherwise fixed volume of the lines 240,246 and associated front and rear brake mechanisms, the fluid pressure increases.

In accordance with the invention, when the fluid pressure in the fluid line 246 increases, the fluid pressure causes the accumulator to accumulate fluid. As indicated above, in the embodiment accumulators 20,120 of the invention, the increase in fluid pressure causes the piston 34,134 of the accumulators 20,120 to move, enlarging a chamber within the accumulator, thus providing space for accommodating fluid.

The increased fluid pressure in the lines 240,246 is transmitted to the front and rear brake mechanisms 242,244,248,250, which affects actuation of those mechanisms. In accordance with the invention, however, the accumulator 252 temporarily accumulates some of the fluid which is transmitted into the system, thus preventing the fluid pressure from rising to such an extent that the braking force becomes excessive and causes the braking mechanisms to lock the wheels.

The brake system 220 has particular utility in racing vehicles. Without the accumulator of the invention, such a system may have to be adjusted with maximum front brake bias in order to prevent rear wheel lock-up during braking. With the inclusion of the accumulator as described, the system 220 can be configured with a rear brake bias. For example, the system 220 can be configured with more rear brake bias, thus permitting the rear wheels to provide significantly more braking force to the vehicle, without the rear wheels locking during braking.

In a preferred embodiment, the brake system 220 includes an accumulator such as illustrated in FIG. 2 and described above. In that configuration, the user may adjust the operation of the accumulator.

The adjustable accumulator 120 has many advantages over other accumulators of the prior art. As described, in an adjustable brake system, the amount of brake bias maybe frequently adjusted based upon a number of conditions, including track conditions, size of brake calipers and other factors. In that situation, the accumulator 120 of the invention can be adjusted to match changes in the brake system settings. For example, if the brake bias is changed to increase rear braking force, the accumulator 120 may be adjusted to accumulate more fluid to prevent rear brake lock when the brakes are applied. In the case where fixed or “non-variable” accumulators are utilized, this eliminates the need to replace the accumulator each time the brake system is adjusted.

The brake system including an accumulator in accordance with the present overcomes the problem of brake lock which is not effectively addressed by proportioning valves. In accordance with the present invention, the accumulator of the brake system is effective in temporarily accumulating an excessive volume of brake fluid in the brake system when brakes are applied quickly with force. Control over the volume of brake fluid in the brake line addresses the underlying cause of pressure spikes, and thus brake lock. This is a significant advantage over proportioning valves, which only reduce the size of such spikes, still permitting such spikes, and associated brake lock, to occur.

The braking system of the invention may vary from that described. For example, the mechanism for controlling the amount of pressure applied/generated by the master cylinders may vary, and need not comprise the brake bias rod configuration specifically described. In some situations, it may be found beneficial for the brake system to include a fluid accumulator associated with the front wheel braking system (such as along line 240 of the system illustrated in FIG. 3), or a system where an accumulator is associated with both the front and rear wheel braking mechanisms.

Various alternate configurations of the accumulators are contemplated and, as described below, a variety of different types of accumulators may be utilized with the braking system of the invention, other than those specifically described above. In one embodiment, the accumulator which is utilized with the braking system may be of other configurations.

The means for biasing the piston of the accumulator maybe other than a spring. For example, such biasing maybe provided by a resilient closed-cell sponge, resilient heavy-walled elastomeric bag (such as pre-charged with a pressurized gas) and/or a solid elastomeric member. In one or more embodiments, the piston and biasing mechanism may be unitary, with the piston comprising a resilient member. For example, the piston may simply comprise a resilient elastomeric body which is positioned in the interior of the housing.

The accumulator may have other porting arrangements. For example, one port may lead into the accumulator and one port may lead out of the accumulator.

Other means may be provided for selectively changing the bias of the piston or other member located inside of the accumulator. For example, in an embodiment where the piston or biasing member associated with the piston comprises an elastomeric bag, means maybe provided for changing the charging pressure of the bag. In an embodiment where the piston or the biasing member associated with the piston comprises a resilient elastomeric member, the member maybe formed as rings, the number of which may be changed to change the total biasing force.

It is noted that the embodiment accumulator 20 illustrated in FIG. 1 maybe configured to be adjustable. For example, shims maybe placed between the spring 40 and the dividing wall 36 or between the spring 40 and the spring mount 42 as a means for selecting or adjusting the biasing force which is applied to the piston 34.

The configuration of the accumulators may vary. For example, the piston might be a closed head member, rather than an open cylinder with a dividing wall. The housing and associated components might vary in shape, such as by being oval in configuration.

In one embodiment, a vent maybe provided from the second chamber 32,132 to the exterior of the housing to permit air behind the piston 34,134 to exit the housing when the piston is compressed rearwardly, thus reducing air pressure behind the piston and associated counter-acting force. In another embodiment, that chamber might be evacuated of air.

It will be appreciated that while the accumulators of the invention have particular utility to the brake system described and illustrated, the accumulators of the invention maybe used with other brake systems. Such systems may comprise brake systems which do not include a balance bar or multiple master cylinders.

It will be understood that the above described arrangements of apparatus and the method there from are merely illustrative of applications of the principles of this invention and many other embodiments and modifications maybe made without departing from the spirit and scope of the invention as defined in the claims.

1. A vehicle braking system comprising:
a first master cylinder;
at least one first fluid line leading from said first master cylinder to at least one first fluid-actuated braking mechanism;
a second master cylinder;
at least one second fluid line leading from said second master cylinder to at least one second fluid-actuated braking mechanism;
an actuating member configured to actuate said first and second master cylinders and cause said first and second master cylinders to dispense fluid into said at least one first and at least one second fluid lines, a position of said actuating member adjustable to adjust the amount of fluid dispensed by said first and second master cylinders relative to one another; and
at least one fluid accumulator associated with said at least one second fluid line, said accumulator configured to selectively accumulate fluid which is dispensed into said at least one second fluid line by said second master cylinder.

2. The vehicle braking system in accordance with claim 1 wherein a pair of first fluid-actuated braking mechanisms are associated with a pair of front wheels of said vehicle.

3. The vehicle braking system in accordance with claim 2 wherein said first braking mechanisms comprise disc-type braking mechanisms including at least one caliper configured to move at least one brake pad into engagement with a rotor.

4. The vehicle braking system in accordance with claim 1 wherein a pair of first fluid-actuated braking mechanisms are associated with a pair of front wheels of said vehicle and a pair of second fluid-actuated braking mechanisms are associated with a pair of rear wheels.

5. The vehicle braking system in accordance with claim 1 wherein said actuating member comprises a brake pedal connected to a balance bar by a first connecting member, and including a second connecting member extending between said balance bar and said first master cylinder and a third connecting member extending between said balance bar and said second master cylinder.

6. The vehicle braking system in accordance with claim 5 wherein said balance bar has a first length between said first connecting member and said second connecting member and a second length between said first connecting member and said third connecting member.

7. The vehicle braking system in accordance with claim 6 wherein said first and second lengths of said balance bar are adjustable relative to one another.

8. The vehicle braking system in accordance with claim 1 wherein said fluid accumulator includes a fluid collecting chamber.

9. The vehicle braking system in accordance with claim 8 wherein a member is movably mounted in said accumulator and configured to change the size of said fluid collecting chamber, and including means for changing a fluid force necessary to move said member and increase the size of said chamber.

10. A fluid accumulator for a brake system comprising:
a housing defining an interior space;
a body movably mounted in said interior space and cooperating with said housing to define a fluid chamber;
at least one port through said housing leading to said fluid chamber;
at least one member generating a biasing force applied to said body causing said body to move to a position wherein the size of said fluid chamber is reduced; and
means for adjusting a biasing force generated by said at least one member.

11. The fluid accumulator in accordance with claim 10 wherein said body comprises a piston member.

12. The fluid accumulator in accordance with claim 11 wherein said at least one member generating a biasing force comprises a spring.

13. The fluid accumulator in accordance with claim 12 wherein said spring has a first end and a second end, said first end engaging a spring mount and said second end engaging said piston, and wherein said means for adjusting comprises means for changing a position of said spring mount.

14. The fluid accumulator in accordance with claim 13 wherein said means for changing a position of said spring mount comprises a member connected to said housing and movable relative to said housing, said member supporting said spring mount.

15. The fluid accumulator in accordance with claim 10 including at least one bleed port extending through said housing to said fluid chamber.

16. The fluid accumulator in accordance with claim 10 wherein said housing has a first open end, an end cap is connected to said housing and generally encloses said first open end of said housing, said end cap defining a passage there through, wherein said body comprises a piston, said means for generating a biasing force comprises a spring, and said means for adjusting comprises a rod extending through said passage in said end cap into engagement with said spring.

17. The fluid accumulator in accordance with claim 16 wherein said rod has a first end and a second end, said first end defining a spring mount engaging said spring and a knob located at said second end, said knob located exterior to said housing.
